(19) United States
(12) Patent Application Publication
(10) Pub. No.: US 2026/0109244 A1
(43) Pub. Date: Apr. 23, 2026

(54) MULTI-PORT CHARGER

(71) Applicant: Solution X Co.,Ltd., Seoul (KR)

(72) Inventor: Se Wan CHOI, Seoul (KR)

(73) Assignee: Solution X Co.,Ltd., Seoul (KR)

(21) Appl. No.: 19/115,794

(22) PCT Filed: Aug. 25, 2023
(86) PCT No.: PCT/KR2023/012689

§ 371 Date: Mar. 27, 2025

(30) Foreign Application Priority Data
Nov. 4, 2022 (KR) 10-2022-0146199

(51) Int. Cl. B60L 53/22; B60L 55/00; H02M 1/14; H02M 3/158; H02M 7/797; H02M 7/86

(52) U.S. Cl. CPC B60L 53/22; B60L 55/00; H02M 1/14; H02M 3/1586; H02M 7/797; H02M 7/86

(57) ABSTRACT

Disclosed is a multi-port charger capable of charging a higher-voltage battery by boosting low DC charging voltage using an on-board charger (OBC) installed in a vehicle without adding a separate part or device and capable of being used for various applications, such as V2G and V2L, in addition to charging.

### CROSS-REFERENCE TO PRIOR APPLICATIONS

This Application is a National Stage Patent Application of PCT International Application No. PCT/KR2023/012689 (filed on Aug. 25, 2023), which claims priority to Korean Patent Application No. 10-2022-0146199 (filed on Nov. 4, 2022), which are all hereby incorporated by reference in their entirety.

### BACKGROUND

The present invention relates to a multi-port charger, and more particularly to a multi-port charger capable of charging a higher-voltage battery by boosting a low DC charging voltage using an on-board charger (OBC) installed in a vehicle without adding a separate part or device and capable of being used for various applications, such as V2G and V2L, in addition to charging.

As electric vehicles trend toward higher performance, the voltage of a battery configured to store electrical energy necessary to drive a motor, which is a power source for electric vehicle, is also increasing. For example, existing electric vehicles adopt a 400V battery, whereas new electric vehicles recently released have an 800V battery in some cases.

However, the existing charging infrastructure is mostly constituted by charging facilities for 400V charging, and in order to charge an 800V battery of each newly launched electric vehicle, a power conversion device for voltage boosting must be added to the vehicle or infrastructure having new 800V charging facilities must be built.

However, adding the power conversion device to the vehicle not only complicates the structure of a vehicle circuit but also significantly increases the unit price of the vehicle. In addition, construction of new infrastructure also requires a lot of social costs and time.

### SUMMARY

Therefore, it is an object of the present invention to provide a multi-port charger capable of charging a higher-voltage battery by boosting a low DC charging voltage using an on-board charger installed in a vehicle without adding a separate part or device and capable of being used for various applications, such as V2G and V2L, in addition to charging.

Objects of the present invention are not limited to the aforementioned object, and other unmentioned objects and advantages of the present invention will be understood by the following description, and will become more apparent by embodiments of the present invention. In addition, it will be readily apparent that the objects and advantages of the present invention can be realized by the means and combinations recited in the appended claims.

As a means for achieving the above object, the present invention provides a multi-port charger including:
a first bidirectional AC-DC converter, a second bidirectional AC-DC converter, and a third bidirectional AC-DC converter, a positive (+) terminal and a negative (−) terminal of a DC side of each of the first to third bidirectional AC-DC converters being electrically connected to each other;
at least one decoupling circuit portion connected to the DC side of each of the first to third bidirectional AC-DC converters, the decoupling circuit portion having a topology of a DC-DC converter;
a first relay configured to determine electrical connection between a voltage application terminal of an AC side of the first bidirectional AC-DC converter and a voltage application terminal of an AC side of the second bidirectional AC-DC converter;
a second relay configured to determine electrical connection between the voltage application terminal of the AC side of the second bidirectional AC-DC converter and a voltage application terminal of an AC side of the third bidirectional AC-DC converter;
a third relay configured to determine electrical connection between a neutral end of the AC side of the first bidirectional AC-DC converter and a neutral end of the AC side of the second bidirectional AC-DC converter; and
a controller configured to control the operation of the first to third bidirectional AC-DC converters, the decoupling circuit portion, and the first to third relays based on an operating mode, wherein
the positive (+) terminal and the negative (−) terminal constitute a first DC port and an output end of the decoupling circuit portion and the negative (−) terminal constitute a second DC port having lower voltage than the first DC port,
the decoupling circuit portion includes a first switching element having one end connected to the positive (+) terminal, a second switching element having one end connected to the other end of the first switching element and the other end connected to connected to the negative (−) terminal, an inductor having one end connected to a connection node of the first switching element and the second switching element and the other end connected to the output end, and a capacitor having both ends connected to the other end of the inductor and the negative (−) terminal, and
the decoupling circuit portion further includes a fourth relay configured to selectively electrically connect one end of the capacitor to one end of the inductor or to a middle point of a secondary coil of a transformer in the third bidirectional AC-DC converter.

In an embodiment of the present invention, in an operating mode of charging a battery connected to the first DC port with DC charging power input to the second DC port, the controller may operate the decoupling circuit portion as a boost converter to boost voltage of the second DC port and to provide the boosted voltage to the first DC port.

In an embodiment of the present invention, in an operating mode of charging a battery connected to the second DC port with DC charging power input to the first DC port, the controller may operate the decoupling circuit portion as a buck converter to step down voltage of the first DC port and to provide the stepped-down voltage to the second DC port.

In an embodiment of the present invention, in an operating mode of providing single-phase AC power to an AC load connected to the AC side while charging the battery connected to the second DC port or the first DC port with DC charging power input to the first DC port or the second DC port, the controller may control the first to third relays to be open and may control the fourth relay such that the capacitor is electrically connected to the middle point of the secondary coil of the third bidirectional AC-DC converter.

In an embodiment of the present invention, each of the first switching element and the second switching element of the decoupling circuit portion may be implemented by a switching element included in at least one of legs corresponding to respective phases of an inverter configured to drive a motor, the inductor of the decoupling circuit portion may be implemented by at least one of respective phase coils provided in the motor connected to the inverter, and a neutral point where the respective phase coils provided in the motor are connected to each other may constitute the output end.

According to various embodiments of a multi-port charger, it is possible to easily convert the magnitude of voltage provided by a charging facility or voltage of a battery by appropriately utilizing a decoupling circuit provided for decoupling without adding a circuit such as a separate converter.

According to the various embodiments of the multi-port charger, therefore, it is possible to utilize existing 400V charging facilities, and therefore it is possible to reduce the cost necessary to provide an additional conversion device or new infrastructure required to charge newly released electric vehicles provided with 800V batteries.

### BRIEF DESCRIPTION OF THE DRAWINGS

The following drawings attached to this specification illustrate preferred embodiments of the present invention and serve to provide a further understanding of the technical idea of the present invention together with the following detailed description of the invention, and therefore the present invention should not be construed as limited to the matters set forth in such drawings.

FIG. 1 is a block diagram showing a multi-port charger according to an embodiment of the present invention.

FIG. 2 is a circuit diagram showing an example of a specific circuit of the multi-port charger of FIG. 1.

FIGS. 3 to 6 are views illustrating the circuit operation in a first operating mode of the multi-port charger according to the embodiment of the present invention.

FIGS. 7 and 8 are views illustrating the circuit operation in a second operating mode of the multi-port charger according to the embodiment of the present invention.

FIGS. 9 to 12 are views illustrating the circuit operation in a third operating mode of the multi-port charger according to the embodiment of the present invention.

FIGS. 13 and 14 are views illustrating the circuit operation in a fourth operating mode of the multi-port charger according to the embodiment of the present invention.

FIGS. 15 and 16 are views illustrating the circuit operation in a fifth operating mode of the multi-port charger according to the embodiment of the present invention.

FIGS. 17 to 19 are views illustrating the circuit operation in a sixth operating mode of the multi-port charger according to the embodiment of the present invention.

FIG. 20 is a circuit diagram showing an example in which first to third decoupling circuit portions of the multi-port charger according to the embodiment of the present invention are implemented by an inverter and a motor.

### DETAILED DESCRIPTION

Specific structural or functional descriptions of embodiments are given only for illustration, and may be realized in various forms. Therefore, the present invention is not limited to specific embodiments, and the scope of the present invention includes all alterations, equivalents, and substitutes that fall within the technical scope of the present invention.

Although the terms “first”, “second”, etc. may be used herein to describe various elements, these terms must be used only to distinguish one element from another. For example, a first element may be referred to as a second element, and similarly, a second element may be referred to as a first element.

It should be understood that, when an element is referred to as being “connected to” another element, the element may be directly connected to or coupled to the other element, or intervening elements may be present.

A singular representation may include a plural representation unless it represents a definitely different meaning from the context. It will be further understood that the terms “comprises”, “has” and the like, when used in this specification, specify the presence of stated features, numbers, steps, operations, elements, components, or combinations thereof, but do not preclude the presence or addition of one or more other features, numbers, steps, operations, elements, components, or combinations thereof.

Unless otherwise defined, all terms, including technical and scientific terms, used in this specification have the same meanings as commonly understood by a person having ordinary skill in the art to which the present disclosure pertains. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

Hereinafter, a preferred embodiment of the present invention will be described in detail with reference to the accompanying drawings.

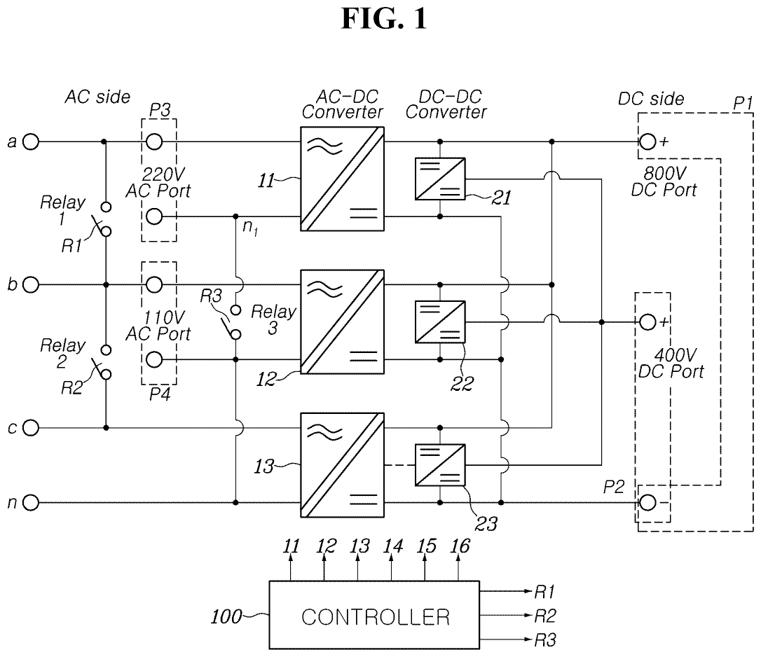

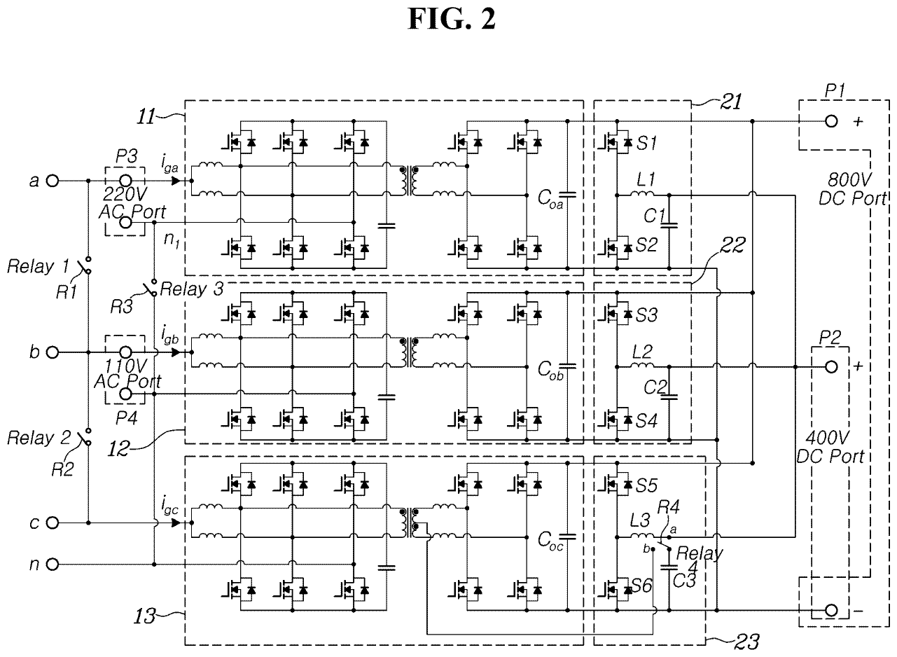

FIG. 1 is a block diagram showing a multi-port charger according to an embodiment of the present invention, and FIG. 2 is a circuit diagram showing an example of a specific circuit of the multi-port charger of FIG. 1.

Referring to FIGS. 1 and 2, the multi-port charger according to one embodiment of the present invention may include: a first bidirectional AC-DC converter 11, a second bidirectional AC-DC converter 12, and a third bidirectional AC-DC converter 13; a first decoupling circuit portion 21, a second decoupling circuit portion 22, and a third decoupling circuit portion 23 connected to a DC side of the first bidirectional AC-DC converter 11, a DC side of the second bidirectional AC-DC converter 12, and a DC side of the third bidirectional AC-DC converter 13, respectively, the first decoupling circuit portion, the second decoupling circuit portion, and the third decoupling circuit portion 23 having the topology of a DC-DC converter; a first relay R1 configured to determine the electrical connection between a voltage application terminal of an AC side of the first bidirectional AC-DC converter 11 and an voltage application terminal of an AC side of the second bidirectional AC-DC converter 12; a second relay R2 configured to determine the electrical connection between the voltage application terminal of the AC side of the second bidirectional AC-DC converter 12 and a voltage application terminal of an AC side of the third bidirectional AC-DC converter 13; a third relay R3 configured to determine the electrical connection between a neutral end of the AC side of the first bidirectional AC-DC converter 11 and a neutral end of the AC side of the second bidirectional AC-DC converter 12; and a controller 100 configured to control the operation of the first to third bidirectional AC-DC converters 11 to 13, the first to third decoupling circuit portions 21 to 23, and the first to third relays R1 to R3 based on an operating mode.

Each of the first to third bidirectional AC-DC converters 11 to 13 may be constituted by a circuit configured to convert AC power input to the AC side and to output the converted power to the DC side or to convert DC power input to the DC side and to output the converted power to the AC side. FIG. 2 shows an example of a bidirectional AC-DC converter implemented based on an interleaved totem pole, but the present invention is not limited thereto, and the topology of various well-known AC-DC converters in which a transformer configured to insulate the DC side and the AC side is used may be adopted.

The specific circuit configuration or operation of the first to third bidirectional AC-DC converters 11 to 13 is disclosed in Korean patent application publication No. 10-2018-0070446 (entitled SINGLE END INTERLEAVED TOTEM POLE SOFT SWITCHING CONVERTER), Korean patent application publication No. 10-2018-0070447 (entitled SINGLE END INTERLEAVED SOFT SWITCHING AC-DC CONVERTER), and Korean patent application publication No. 10-2022-0122915 (entitled THREE-PHASE AND SINGLE-PHASE DUAL CHARGER), filed by the same applicant and inventors as the present application, and therefore a further description thereof will be omitted.

The first to third decoupling circuit portions 21 to 23 may be implemented by applying the topology of a DC-DC converter known in the art. Input ends of the DC-DC converter topology constituting the first to third decoupling circuit portions 21 to 23 may be connected to positive (+) output ends of the DC side of the first to third bidirectional AC-DC converters 11 to 13 and may be electrically connected to each other to constitute one port Pl of the charger, and output ends of the DC-DC converter topology constituting the first to third decoupling circuit portions 21 to 23 may be electrically connected to each other to constitute another port P2.

More specifically, the first decoupling circuit portion 21 may include a first switching element S1 having one end connected to a positive (+) terminal of the DC side of the first bidirectional AC-DC converter 11, a second switching element S2 having one end connected to the other end of the first switching element S1 and the other end connected to connected to a negative (−) terminal of the DC side of the first bidirectional AC-DC converter 11, an inductor L1 having one end connected to a connection node of the first switching element S1 and the second switching element S2, and a capacitor C1 having both ends connected to the other end of the inductor L1 and the negative (−) terminal of the DC side of the first bidirectional AC-DC converter 11.

Each of the second decoupling circuit portion 22 and the third decoupling circuit portion 23 may also have substantially the same circuit structure as the first decoupling circuit portion 21.

However, the third decoupling circuit portion 23 may further include a relay R4 whose connection is controlled by the controller 100 depending on the mode. The relay L4 may selectively connect one end of the capacitor C3 to one end of the inductor L3 or to a middle point of a secondary coil of a transformer in the third bidirectional AC-DC converter 13. The £ operation and effect of the relay R4 will be described in more detail later.

In addition, although the various embodiments and drawings of the present invention illustrate an example in which one decoupling circuit portion is connected to the DC side of each AC-DC converter, only one decoupling circuit portion may be adopted if the capacity of each of the elements constituting the decoupling circuit portion is sufficiently large.

The connection of the first to third relays R1 to R3 may be controlled by the controller 100 depending on the operating mode of the charger. For example, if three-phase AC charging power is input to the charger, the first to second relays R1 and R2 may be controlled to be off, whereby AC charging power is input to each of the first to third bidirectional AC-DC converters 11 to 13. As another example, if single-phase AC charging power is input to the charger, the first to second relays R1 and R2 may be controlled to be on, whereby common AC charging power may be input to the first to third bidirectional AC-DC converters 11 to 13. In addition, when each of the AC side of the first bidirectional AC-DC converter 11 and the AC side of the second bidirectional AC-DC converter 12 outputs AC power, the third relay R3 may be turned off to separate the two AC outputs from each other.

As such, the charger according to the embodiment of the present invention may have a multi-port structure configured by input/output terminals of the AC sides of the first to third bidirectional AC-DC converters 11 to 13, input/output terminals of the DC sides of the first to third bidirectional AC-DC converters 11 to 13, and terminals formed by the first to third decoupling circuit portions 21 to 23. Hereinafter, an example in which the embodiment of the present invention is operated in various modes using such a multi-port structure will be described in more detail.

Meanwhile, the technique of performing the decoupling operation in the state in which a decoupling circuit having the topology of the DC-DC converter circuit is provided on the DC side for decoupling in a single-phase operation is also well known in the art, and therefore a description of the specific operation technique will be omitted.

### 1. High-Voltage Battery Charging Using Low-Voltage Fast Charging Facility

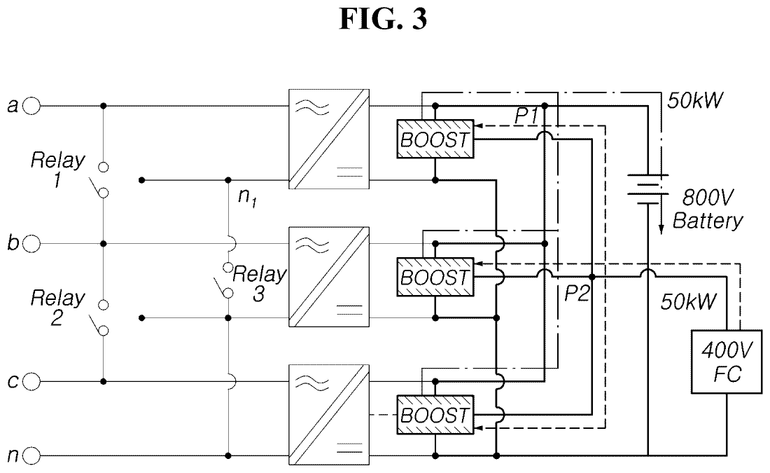

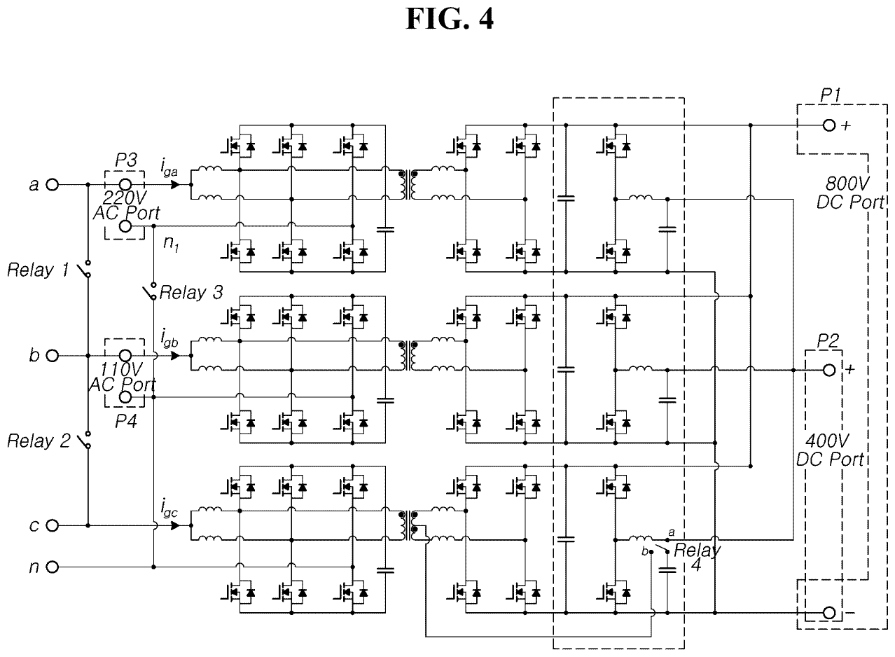

FIGS. 3 to 6 are views illustrating the circuit operation in a first operating mode of the multi-port charger according to the embodiment of the present invention.

As shown in FIGS. 3 to 6, when a 400V-class fast charging facility is connected to the port P2 located between the positive (+) terminal and the negative (−) terminal of the DC side corresponding to the output terminals of the DC-DC converter constituted by the first to third decoupling circuit portions 21 to 23 and 400V-class DC charging power is applied, the controller 100 may turn off the first to third bidirectional AC-DC converters 11 to 13, may operate the first to third decoupling circuit portions 21 to 23 as a boost converter to boost the charging power applied to port P2, and may supply the boosted charging power to a 800V battery connected to the port P1.

In this operating mode, all of the first to third decoupling circuit portions 21 to 23 must operate as a boost converter, and therefore the controller 100 may perform control such that the relay R4 is electrically connected to one end of the inductor L3, and may perform pulse width modulation control on switching elements S1 to S6 in the first to third decoupling circuit portions 21 to 23 such that the voltage of the DC power input to port P2 can be boosted and output to port Pl.

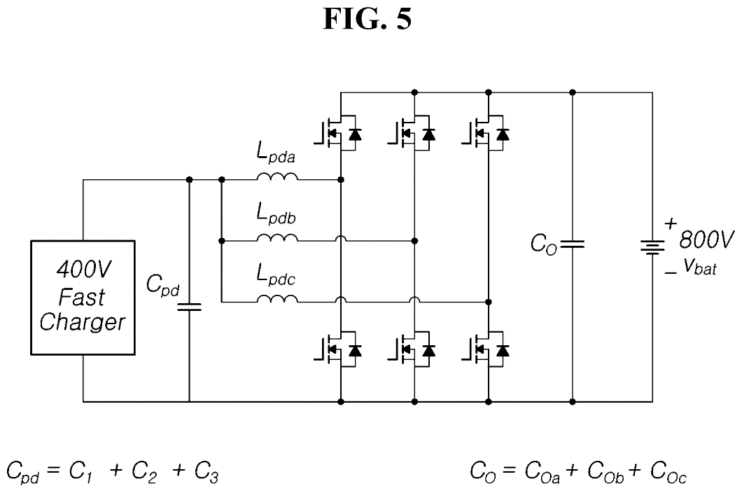

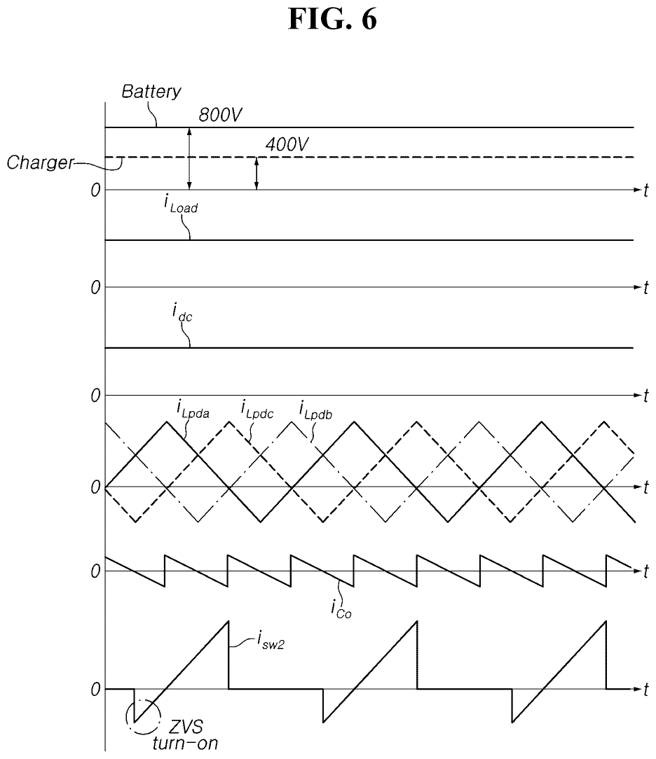

That is, in this operating mode, an interleaved boost converter as shown in FIG. 5 may be implemented between the 400V-class fast charging facility and the 800 V battery, and the operating waveform thereof is shown in FIG. 6.

In this operating mode, the power (50 kW) provided by the 400V-class charging facility may be delivered to the 800 V battery without any change, provided that the ideal, lossless operation is performed.

### 2. High-Voltage Battery Charging and Three-Phase Slow Charging Using Low-Voltage Fast Charging Facility (or Three-Phase AC Output (V2G))

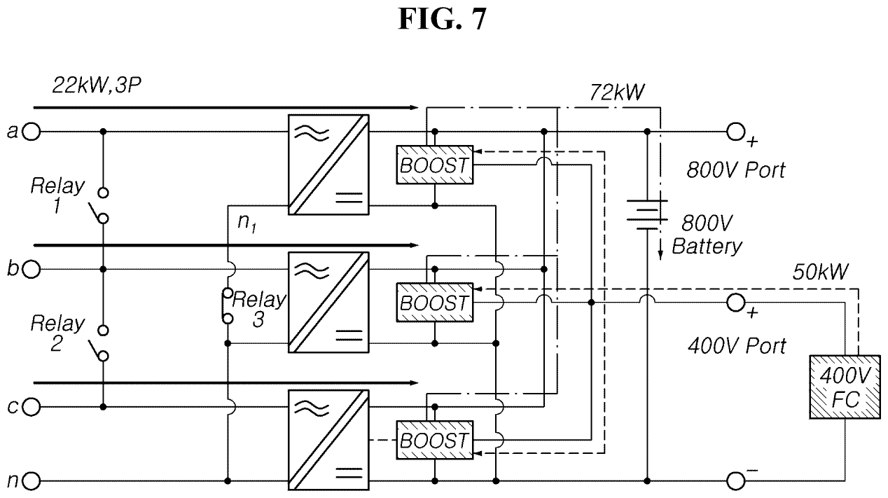

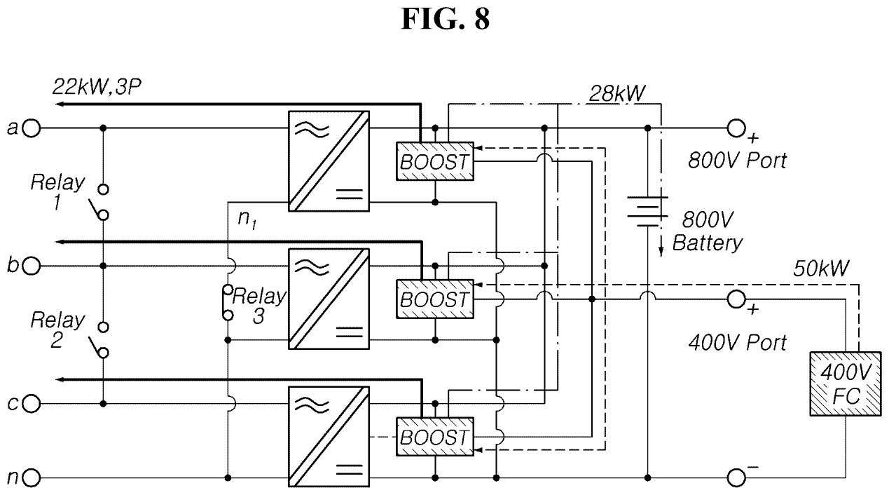

FIGS. 7 and 8 are views illustrating the circuit operation in a second operating mode of the multi-port charger according to the embodiment of the present invention.

In this operating mode, operating the first to third decoupling circuit portion 21 to 23 as a boost converter in order to boost charging power input from the 400V-class fast charging facility to the port P2 and to supply the boosted charging power to the 800V battery of the port Pl is the same as described with reference to FIGS. 5 and 6.

However, as shown in FIG. 7, in this mode, three-phase AC charging power may be input to the AC side of each of the first to third bidirectional AC-DC converters 11 to 13, the input three-phase AC charging power may be converted into DC power, and the DC power may be provided to the port P2 to provide additional charging power to the 800V battery.

In this case, the controller 100 may perform pulse width modulation control on the switching element of each of the first to third bidirectional AC-DC converters 11 to 13 to convert input AC power of the AC side of the first to third bidirectional AC-DC converters 11 to 13 and to provide the converted power to the DC side. In addition, in order for each of the first to third bidirectional AC-DC converters 11 to 13 to perform power conversion corresponding to one phase, the controller 100 may turn off relays R1 and R2 so as to be open and may turn on the relay R3 so as to be short-circuited.

If the ideal, lossless operation is performed through this control, the sum of the power (50 kW) provided by the 400V-class charging facility and the AC charging power (22 kw) input to the AC side may be provided to the 800V battery, enabling faster charging of the battery.

In addition, in this mode, as shown in FIG. 8, when the first to third bidirectional AC-DC converters 11 to 13 perform a vehicle-to-grid (V2G) operation of converting DC power and providing the converted power to the AC side, three-phase AC power may be supplied from port P2 to the AC side of each of the first to third bidirectional AC-DC converters 11 to 13.

In this case, the controller 100 may perform pulse width modulation control on the switching element of each of the first to third bidirectional AC-DC converters 11 to 13 to convert the power of the DC side of the first to third bidirectional AC-DC converters 11 to 13 and to provide the converted power to the AC side. In addition, in order for each of the first to third bidirectional AC-DC converters 11 to 13 to perform power conversion corresponding to one phase, the controller 100 may turn off relays R1 and R2 so as to be open and may turn on the relay R3 so as to be short-circuited.

If the ideal, lossless operation is performed through this control, a converted AC power of 22 kW may be provided to the AC side, and the 800V battery may be charged with a charging power of 28 kw.

### 3. High-Voltage Battery Charging and Single-Phase AC Output Using Low-Voltage Fast Charging Facility (V2L)

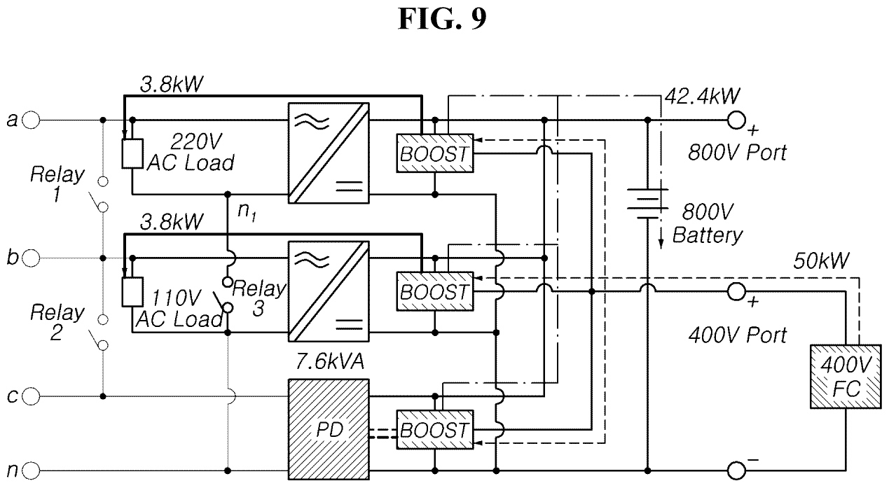

FIGS. 9 to 12 are views illustrating the circuit operation in a third operating mode of the multi-port charger according to the embodiment of the present invention.

The third operating mode is a mode of performing a vehicle-to-load (V2L) operation that provides AC power to an AC load connected to the AC side of the first to third bidirectional AC-DC converters 11 to 13 while charging the 800V battery with charging power input to the port P2 through the 400V-class fast charging facility.

In this operating mode, operating the first to third decoupling circuit portions 21 to 23 as a boost converter in order to boost charging power input from the 400V-class fast charging facility to the port P2 and to supply the boosted charging power to the 800V battery of the port Pl is the same as described with reference to FIGS. 5 to 8.

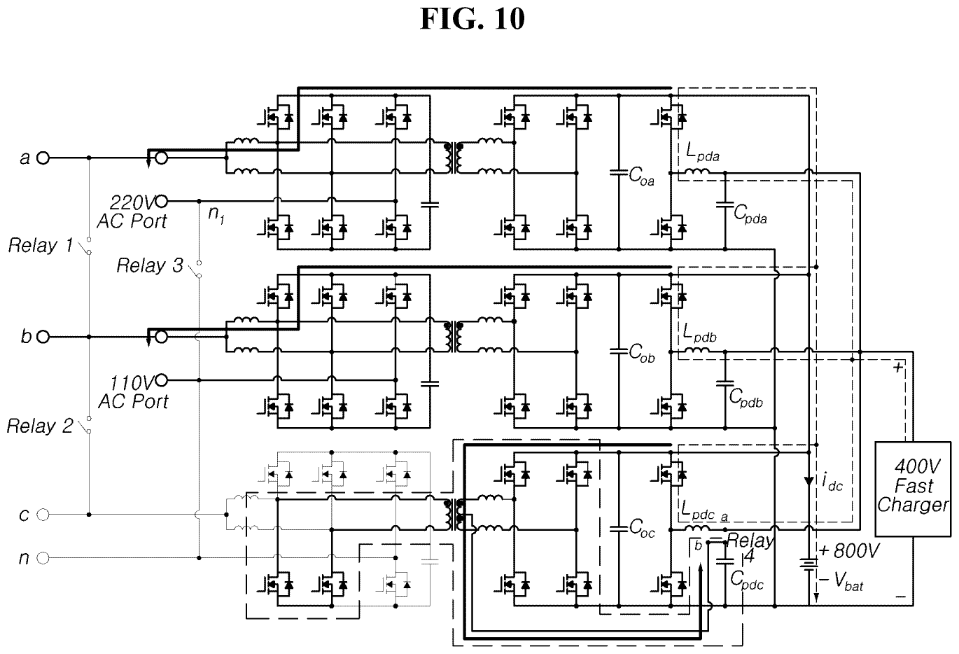

However, as shown in FIGS. 9 and 10, in order to supply AC power to an AC load connected to each of the first bidirectional AC-DC converter 11 and the second bidirectional AC-DC converter 12, the controller 100 turns off the relays R1 to R3 so as to be open such that the AC side of the first bidirectional AC-DC converter 11 and the AC side of the second bidirectional AC-DC converter 12 are separated from each other and controls the relay R4 in the third decoupling circuit such that the capacitor C3 is electrically connected to the middle point of the secondary coil in the third bidirectional AC-DC converter 13.

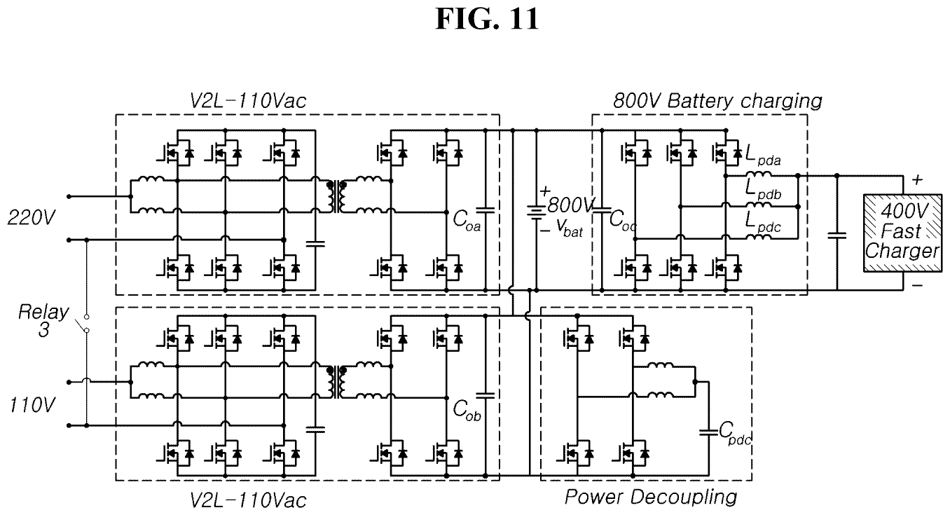

A circuit implemented through control of the controller 100 is shown in FIG. 11.

As shown in FIG. 11, if the capacitor C3 is electrically connected to the middle point of the secondary coil of the third bidirectional AC-DC converter 13 and the switching element in the third bidirectional AC-DC converter 13 is short-circuited, a decoupling circuit having the topology of a two-phase interleaved buck converter is constituted. This decoupling circuit allows low frequencies such as secondary harmonics generated by a single-phase operation to be stored in the capacitor C3, thereby removing ripple from the DC current supplied to the battery. Accordingly, all of the first to third decoupling circuits may be used for voltage boosting to charge the 800V battery, which allows the magnitude of fast charging power to be maximized. That is, if AC power used by each AC load is 3.8 kw, the maximum power (42.4 kw), obtained by subtracting the power provided to each load from the power (50 kW) provided by the quick charger, may be provided to the battery.

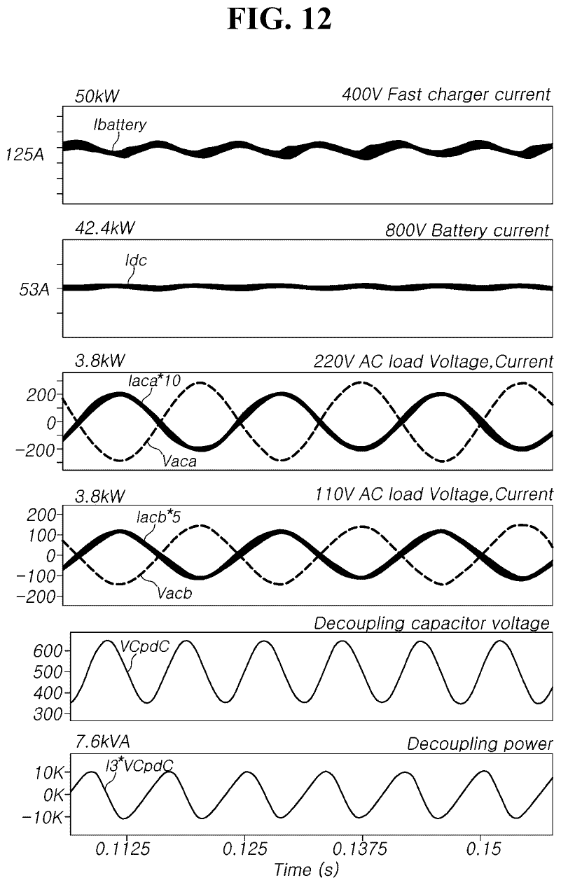

That is, the operation waveform formed in this operation mode is shown in FIG. 12.

### 4. Battery Charging and Supply of Power to DC Load or AC Load Using High-Voltage Fast Charging Facility

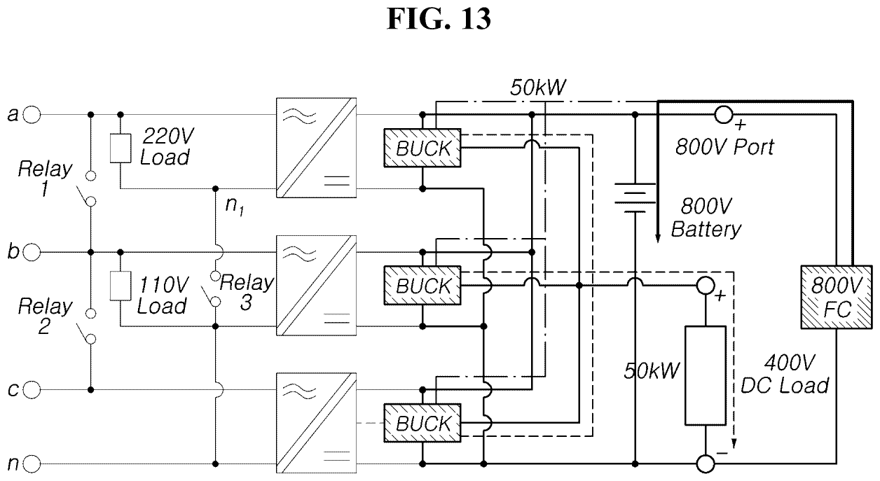

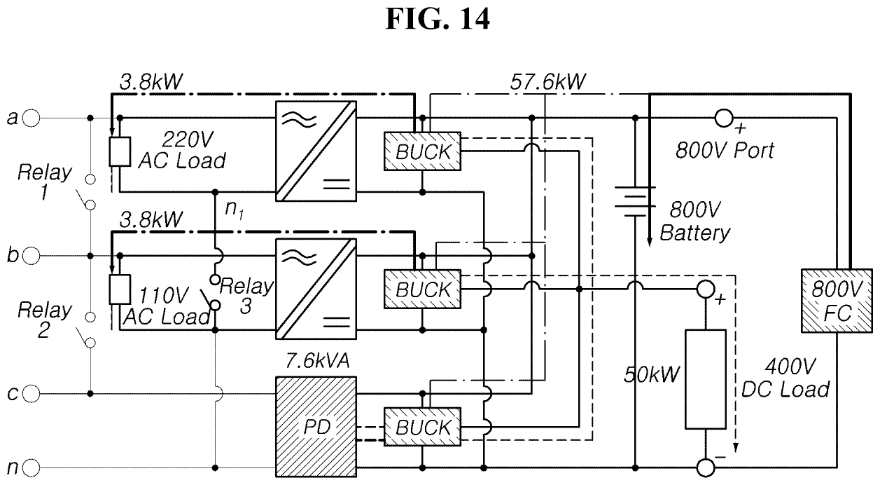

FIGS. 13 and 14 are views illustrating the circuit operation in a fourth operating mode of the multi-port charger according to the embodiment of the present invention.

The fourth operating mode is a mode for performing a vehicle-to-load (V2L) operation that provides AC power to a DC load connected to the port P2 or an AC load connected to the AC side of the first to third bidirectional AC-DC converters 11 to 13 while charging the 800V battery with charging power input to the port P1 through an 800V-class fast charging facility.

As shown in FIG. 13, when only a DC load is connected to the port P2, the 800V battery may be charged with the charging power input from the 800V-class fast charging facility to port P1, and the controller 100 may operate the first to third decoupling circuits 21 to 23 as a buck converter to step down the voltage of the port P1 and to supply the stepped-down voltage to a 400V-class DC load of the port P2.

As shown in FIG. 14, when AC power is supplied to an AC load connected to each of the first bidirectional AC-DC converter 11 and the second bidirectional AC-DC converter 12, the controller 100 may operate the first to third decoupling circuits 21 to 23 as a buck converter, may turn off the relays R1 to R3 so as to be open such that the AC side of the first bidirectional AC-DC converter 11 and the AC side of the second bidirectional AC-DC converter 12 are separated from each other, and may control the relay R4 in the third decoupling circuit such that the capacitor C3 is electrically connected to the midpoint of the secondary coil in the third bidirectional AC-DC converter 13 and switching element in the third bidirectional AC-DC converter 13 is short-circuited.

The maximum power may be supplied to the DC load connected to the port P2 through control of the controller 100, and a decoupling circuit having the topology of a two-phase interleaved buck converter may be constituted by the third bidirectional AC-DC converter 13, whereby low frequencies such as secondary harmonics generated by a single-phase operation may be stored in the capacitor C3, and therefore it is possible to remove ripple from the DC current supplied to the battery. Accordingly, all of the first to third decoupling circuits may be used for voltage drop.

### 5. Charging Between Two Batteries Having Different Voltages

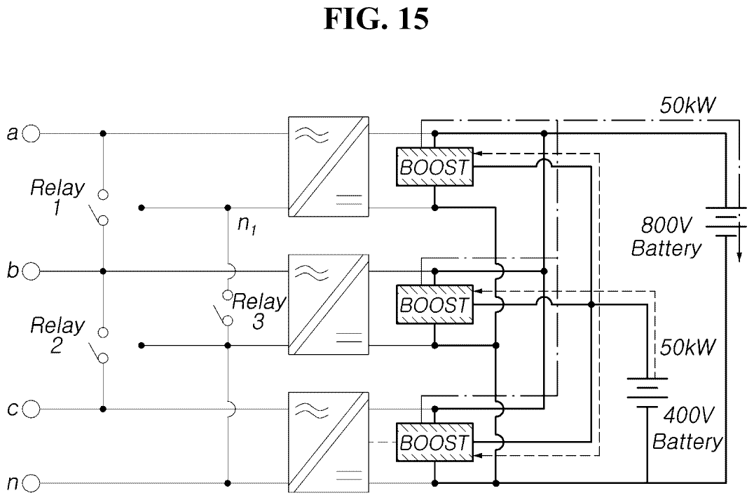

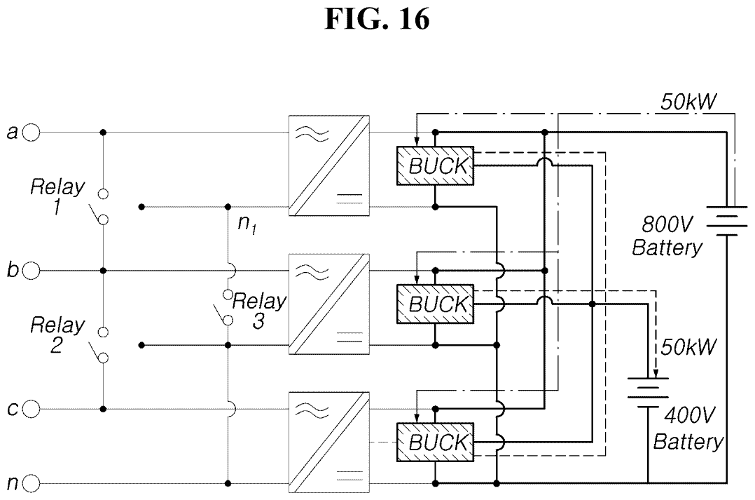

FIGS. 15 and 16 are views illustrating the circuit operation in a fifth operating mode of the multi-port charger according to the embodiment of the present invention.

The fifth operating mode is a mode of performing mutual charging when a battery having relatively high voltage (e.g., 800 V) is connected to the port P1 and a battery having relatively low voltage (e.g., 400 V) is connected to the port P2.

As shown in FIG. 15, when the controller 100 operates all of the first to third decoupling circuits 21 to 23 as a boost converter, the voltage of the 400V battery may be boosted and supplied to the 800V battery such that the 800V battery can be charged.

As shown in FIG. 16, when the controller 100 operates all of the first to third decoupling circuits 21 to 23 as a buck converter, the voltage of the 800V battery may be stepped down and supplied to the 400V battery such that the 400V battery can be charged.

### 6. AC charging or V2G (DC-DC converter not operated)

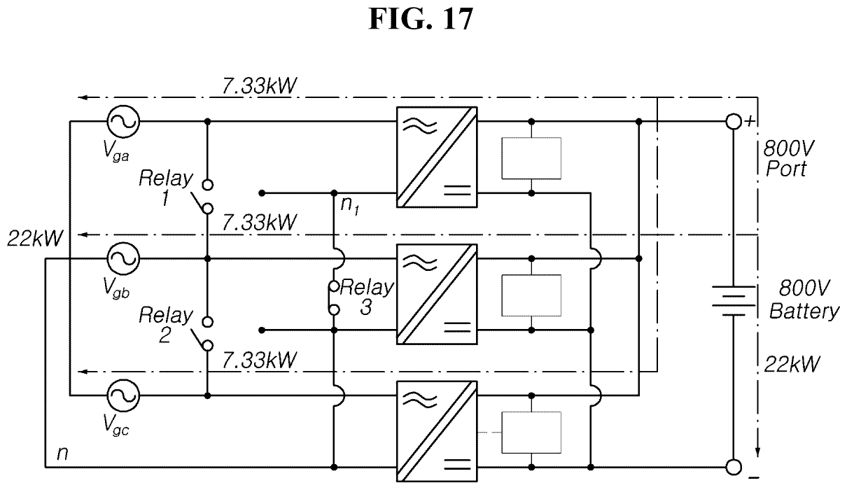

FIGS. 17 to 19 are views illustrating the circuit operation in a sixth operating mode of the multi-port charger according to the embodiment of the present invention.

FIG. 17 shows a mode for performing a V2G operation that converts three-phase AC charging power input to the AC side of the first to third bidirectional AC-DC converters 11 to 13 and charges the 800V battery connected to port Pl with the converted power or converts DC power of the 800V battery and supplies the converted power to the AC side of the first to third bidirectional AC-DC converter 11 to 13 as a three-phase AC system.

As shown in FIG. 17, when the first to third bidirectional AC-DC converters 11 to 13 perform three-phase charging or V2G operation, the low-frequency component is naturally offset on the DC output side, enabling ripple-free battery DC charging and V2G, and therefore the first to third decoupling circuits 21 to 23 are not operated. That is, the controller 100 may turn on the first to third bidirectional AC-DC converters 11 to 13 so as to be operated and may turn off the first to third decoupling circuits 21 to 23. Of course, since three-phase AC input or output is required, the controller 100 may turn off the relays R1 and R2, and may turn on the relay R3.

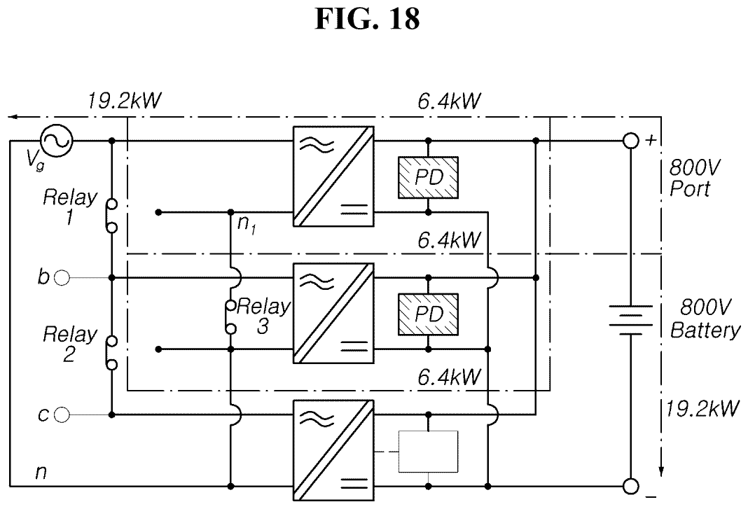

FIG. 18 shows a mode of performing a V2G operation that converts single-phase AC charging power input to the AC side of the first to third bidirectional AC-DC converter 11 to 13 and charges the 800V battery connected to the port P1 with the converted power or converts the DC power of the 800V battery and supplies the converted power to the AC side of the first to third bidirectional AC-DC converter 11 to 13 as a single-phase system.

As shown in FIG. 18, in order for the first to third bidirectional AC-DC converters 11 to 13 to have single-phase input or output, the controller 100 may control the relays RI to R3 so as to be short-circuited. Since ripple offset through current merging for each phase cannot be achieved in single-phase charging or V2G operation, unlike three-phase charging or V2G, control may be performed such that decoupling by the first to third decoupling circuits 21 to 23 is performed.

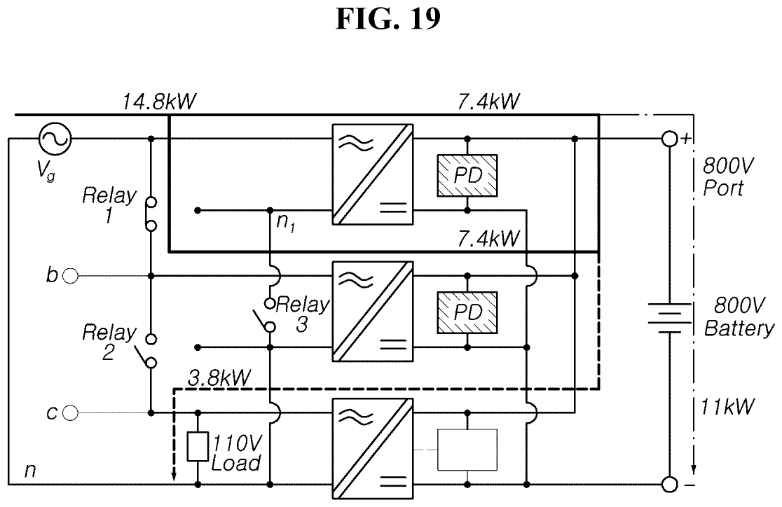

FIG. 19 shows a mode for performing 800V charging or a V2G operation by the two bidirectional AC-DC converters 11 and 12 and a V2L operation that supplies power to an AC load connected to the AC side of the other AC-DC converter 13.

Even in this case, the controller 100 may perform control such that decoupling by the first and second decoupling circuits 21 and 22 is performed, may control the switching elements in the decoupling circuits 21 and 22, and may perform control such that the DC side voltage is converted by the bidirectional AC-DC converters 11 to 13 and provided to the AC side. In addition, since the two bidirectional AC-DC converters 11 and 12 provide single-phase AC power, the controller 100 may turn on the relay R1, and may open the relays R2 and R3 to release the connection with the AC load.

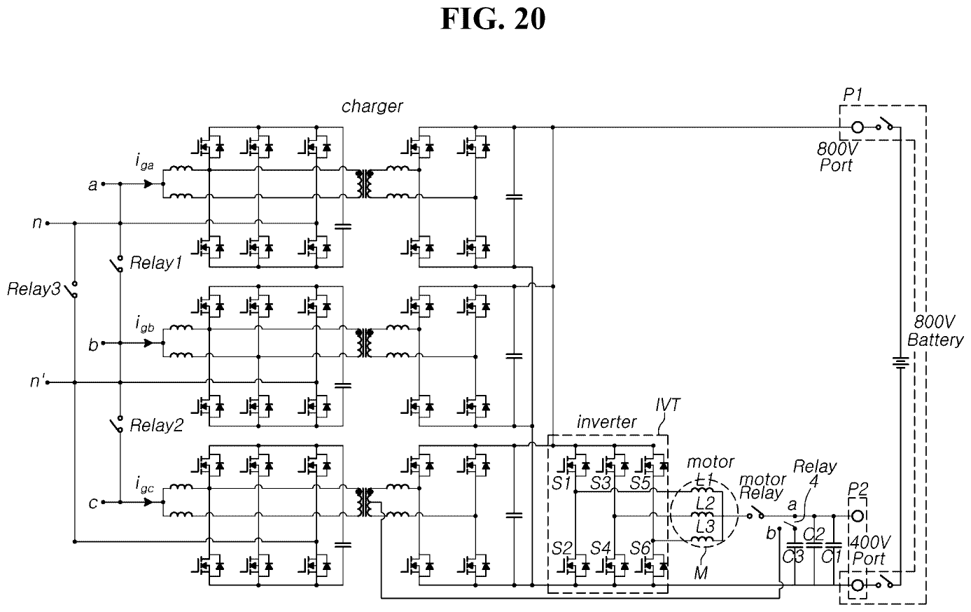

FIG. 20 is a circuit diagram showing an example in which first to third decoupling circuit portions of the multi-port charger according to the embodiment of the present invention are implemented by an inverter and a motor.

Referring to FIG. 20, in the embodiment of the present invention, the first to third decoupling circuit portions may be implemented using an inverter and a motor installed in an electric vehicle.

More specifically, first switching elements S1, S3, and S5 and second switching elements S2, S4, and S6 of the first to third decoupling circuit portions may be implemented by two switching elements included in a leg corresponding to each phase of an inverter IVT provided to drive a motor.

In addition, inductors L1, L2, and L3 of the first to third decoupling circuit portions may be implemented by respective phase coils in the motor M connected to a node to which the two switching elements included in the legs corresponding to each phase of the inverter IVT are connected.

The neutral point where the respective phase coils in the motor M are connected to each other may be an output terminal connected in common to the first to third decoupling circuit portions.

As such, even if a pre-installed on-board charger has a structure having no decoupling circuit portion, the multi-port charger according to the embodiment of the present invention is configured such that a decoupling circuit portion is implemented using a pre-installed motor and an inverter circuit configured to drive the motor, thereby enabling charging at various voltages without adding a separate circuit or significantly changing the circuit design to implement multi-port charging.

As described above, the multi-port charger according to various embodiments of the present invention can easily convert the magnitude of the voltage provided by the charging facility or the voltage of the battery by appropriately utilizing the decoupling circuit provided for decoupling without adding a circuit such as a separate converter.

Accordingly, it is possible to reduce the cost of additional conversion apparatus or new infrastructure required to charge an electric vehicle provided with a newly released 800V battery using the existing 400V charging facility.

### DESCRIPTION OF REFERENCE NUMERALS

11 to 13: Bidirectional AC-DC converters
21 to 23: Decoupling circuit portions
100: Controller

1. A multi-port charger comprising:
a first bidirectional AC-DC converter, a second bidirectional AC-DC converter, and a third bidirectional AC-DC converter, a positive (+) terminal and a negative (−) terminal of a DC side of each of the first to third bidirectional AC-DC converters being electrically connected to each other;
at least one decoupling circuit portion connected to the DC side of each of the first to third bidirectional AC-DC converters, the decoupling circuit portion having a topology of a DC-DC converter;
a first relay configured to determine electrical connection between a voltage application terminal of an AC side of the first bidirectional AC-DC converter and a voltage application terminal of an AC side of the second bidirectional AC-DC converter;
a second relay configured to determine electrical connection between the voltage application terminal of the AC side of the second bidirectional AC-DC converter and a voltage application terminal of an AC side of the third bidirectional AC-DC converter;
a third relay configured to determine electrical connection between a neutral end of the AC side of the first bidirectional AC-DC converter and a neutral end of the AC side of the second bidirectional AC-DC converter; and
a controller configured to control operation of the first to third bidirectional AC-DC converters, the decoupling circuit portion, and the first to third relays based on an operating mode, wherein
the positive (+) terminal and the negative (−) terminal constitute a first DC port and an output end of the decoupling circuit portion and the negative (−) terminal constitute a second DC port having lower voltage than the first DC port,
the decoupling circuit portion comprises a first switching element having one end connected to the positive (+) terminal, a second switching element having one end connected to the other end of the first switching element and the other end connected to connected to the negative (−) terminal, an inductor having one end connected to a connection node of the first switching element and the second switching element and the other end connected to the output end, and a capacitor having both ends connected to the other end of the inductor and the negative (−) terminal, and
the decoupling circuit portion further comprises a fourth relay configured to selectively electrically connect one end of the capacitor to one end of the inductor or to a middle point of a secondary coil of a transformer in the third bidirectional AC-DC converter.

2. The multi-port charger according to claim 1, wherein
in an operating mode of charging a battery connected to the first DC port with DC charging power input to the second DC port,
the controller operates the decoupling circuit portion as a boost converter to boost voltage of the second DC port and to provide the boosted voltage to the first DC port.

3. The multi-port charger according to claim 1, wherein
in an operating mode of charging a battery connected to the second DC port with DC charging power input to the first DC port,
the controller operates the decoupling circuit portion as a buck converter to step down voltage of the first DC port and to provide the stepped-down voltage to the second DC port.

4. The multi-port charger according to claim 2, wherein
in an operating mode of providing single-phase AC power to an AC load connected to the AC side while charging the battery connected to the second DC port or the first DC port with DC charging power input to the first DC port or the second DC port,
the controller controls the first to third relays to be open and controls the fourth relay such that the capacitor is electrically connected to the middle point of the secondary coil of the third bidirectional AC-DC converter.

5. The multi-port charger according to claim 1, wherein
each of the first switching element and the second switching element of the decoupling circuit portion is implemented by a switching element included in at least one of legs corresponding to respective phases of an inverter configured to drive a motor,
the inductor of the decoupling circuit portion is implemented by at least one of respective phase coils provided in the motor connected to the inverter, and
a neutral point where the respective phase coils provided in the motor are connected to each other constitutes the output end.
